(19) United States
(12) Patent Application Publication
(10) Pub. No.: US 2006/0207403 A1
(43) Pub. Date: Sep. 21, 2006

(54) Bagel sandwich knife

(76) Inventor: Dennis Moss, Pittsford, NY (US)

Correspondence Address: HISCOCK & BARCLAY, LLP, 2000 HSBC PLAZA, ROCHESTER, NY, 14604-2404, US

(21) Appl. No.: 11/263,092

(22) Filed: Oct. 31, 2005

Related U.S. Application Data
(60) Provisional application No. 60/662,982, filed on Mar. 18, 2005.

(51) Int. Cl. B26D 3/00

(52) U.S. Cl. 83/870

(57) ABSTRACT

A knife 100 has two blades 120.1, 120.2 that are spaced apart from each other and are supported at one pair of ends in a handle 130 and the their other pair of ends 132. Side guards 110.1. and 110.2 extend from the handle to the tips of the blades and extend below the cutting edges of the blades to protect a user from cutting the palm of his or her hand. The cutting edges of blades 120.1, 120.2 are vertically spaced from each other. The relative spaces between the side guards, between the blades, and between the side guards and the blades are adjustable. The knife may have a one or two blades and one or two side guards.

### CROSS-REFERENCE TO RELATED APPLICATIONS

This application claims the benefit of the filing date of U.S. provisional patent application Ser. No. 60/662,982 filed Mar. 18, 2005.

### FIELD OF THE INVENTION

This invention relates to knives, and more specifically to knives used in food preparation.

### BACKGROUND OF THE INVENTION

The preparation of food for cooking and eating usually involves cutting food items such as fruit, vegetables, meat, and dough-based products into smaller pieces for cooking or baking, combination with other items, and presentation to the consumer. For food items to be combined as slices with other foods, as in the preparation of bread, rolls, bagels, or other items too thick for eating alone and uncut, the slicing process is time-consuming, sometimes dangerous to the preparer, and often error-prone in that the results of a slicing operation can be uneven, unattractive, or even unusable in producing the final dish. These problems can result in food wastage, injury, and delays in preparation which are unacceptable in most meal preparation processes.

Bagels present unique problems in preparing a sandwich. A bagel sandwich is made by slicing the bagel in half on a plane perpendicular to the axis of the hole in the bagel. Bagels are quite firm and thick, and present considerable resistance to a cutting blade when being cut. In addition, the outer surface of the bagel is smooth, round, and two-dimensionally convex, making it highly unstable for cutting except when laid flat on a surface and cut horizontally. Horizontal cutting requires more energy and time than downward (vertical) cutting, both to execute the cut and to hold the bagel in position.

The smooth, convex, outer surface of the bagel presents an additional problem when attempting to cut the bagel into thirds or multiple slices on planes perpendicular to the axis of the hole. Most cutting blades directed at a surface at an angle tend to slide along that surface rather than ‘bite’ into it for the cut. Consequently, food preparers do not often try to make bagel sandwiches or other multilayered bagel preparations using conventional cutting methods.

A bagel is most safely cut by laying it on a flat surface, placing the palm of one hand on the top surface of the bagel, and engaging the outer circular edge of the bagel with a serrated bread knife. The knife is moved parallel to the plane of the support surface while the person keeps the fingers of the hand on the bagel and out of the cutting plane of the knife.

Many people are injured while cutting bagels. The source of the injuries is often improper equipment or improper procedures. For example, many people will use an ordinary, non-serrated knife. Such knives more easily slip on the smooth outer convex surface of the bagel and cut the hand that holds the bagel. Other injuries occur when the bagel is cut while standing it on its convex edge.

To address this safety problem several companies offer frames or holders designed to hold a bagel in position for cutting into two or three layers. Among these are the Bagel Trap, a frame with knife slots for slicing a bagel into two or three layers, and the J. P. Products Bagel cutter, also a frame with three knife slots. Neither product includes a knife or blade. Other companies offer combined holders and blades, but only for making a single cut, such as the Bagel Biter, a guillotine-style cutter with a single blade for slicing a bagel into two halves and an enclosure for holding the bagel. Still other firms offer motor-driven cutters, like the Toastmaster Bagel Slicer, which has an enclosure to hold the bagel and a single blade for cutting the bagel in half.

None of the products combine the ability to cut a bagel into three or more slices with the blade or knife for making the cuts and none of the products provides a motor-driven cutter to produce three or more slices of a bagel.

### SUMMARY OF THE INVENTION

The invention includes a knife with or without a bagel holder, the knife further including two or more knife blades capable of being locked firmly side by side of their tangs and tips so as to make parallel cuts in a bagel or similar food item held firmly in the holder. The tangs of the blades are fixed in the knife handle. Optionally, the tips of the blades are fixed in a spacer element between them. The knife blades, when locked in place for operation, are tightly anchored in a single convenient handle to improve the user's control of the cut. The knife blades may be assembled so as to provide two or more different thicknesses of cut between them. The knives may be used with the holder at any of several different slot widths to accommodate the different thicknesses of cut. Each knife blade comprises either a simple blade with a linear or serrated cutting edge, or a motor-driven double-reciprocating blade pair with linear or serrated cutting edges.

In additional embodiments, the invention incorporates a rigid guard that extends from the handle to the tips of the blades so that a food item to be cut passes within the guard. The guard strengthens the knife and reduces the likelihood of exposing fingers or other tissue to the cutting edges of the s. The guards also support the outside surfaces of the bagel where the bagel is being cut, thereby providing added stability for a bagel cut on its convex edge.

Further embodiments incorporate staggered blades and blades positioned so as to center the food item being cut toward the midpoint of the length of the blades.

### BRIEF DESCRIPTION OF THE DRAWINGS

FIG. 1A shows a bagel with markings indicating where the invention's cuts will divide it into three parts.

FIG. 1B shows the bagel after it has been cut by the invention.

FIG. 2A shows a top view of the knife, in a preferred simple embodiment.

FIG. 2B shows a side view of the knife of FIG. 2A, with the blades spaced closer together.

FIG. 2C shows a top view of the knife of FIG. 2A, with the blades spaced farther apart.

FIG. 3A shows a motorized form of the invention's knife, in a preferred simple embodiment.

FIG. 3B shows a top view of the knife of FIG. 3A.

FIG. 3C shows a motorized form of the invention's knife with tip spacers.

FIG. 3D shows a top view of the knife of FIG. 3C, with the blades spaced closer together.

FIG. 3E shows a top view of the knife of FIG. 3C, with the blades spaced farther apart.

FIG. 3F shows a top view of the knife of FIG. 3C, with the blades in paired reciprocating positions at the limits of their movement.

FIG. 4A shows a top view of the invention's knife of FIG. 3A during a cut through a bagel.

FIG. 4B shows a close-up of the cut of FIG. 4A.

FIG. 5A shows the invention's knife of FIG. 3C, bagel holder, and a bagel during a cut.

FIG. 5B shows an end view of the bagel holder for use with the knife of FIG. 3C, with a bagel in position for cutting.

FIG. 6A shows the invention's knife of FIG. 3B, bagel holder, and a bagel during a cut.

FIG. 6B shows an end view of the bagel holder for use with the knife of FIG. 3B, with a bagel in position for cutting.

FIG. 7 shows the invention's bagel holder with removable bagel holding parts.

FIG. 8A shows the invention's knife of FIG. 2C with blade spacers.

FIG. 8B shows the invention's knife of FIG. 2B with blade spacers.

FIGS. 9A-9H show stages in the conversion of the blade spacing of the knife of FIG. 2C to the blade spacing of the knife in FIG. 2B.

FIG. 10 shows a side view of the knife with two guards.

FIG. 11 shows a top view of the knife with two guards.

FIG. 12 shows internal detail of the knife with two guards, in the top view.

FIG. 13 shows three different blades for use in the knife having two guards.

FIG. 14 shows the major components of the knife with two guards ordered for assembly, in a side view of each component.

FIG. 15 shows the major components of the knife with two guards ordered for assembly, in a top view of each component.

FIG. 16 shows an inverted closed-side view of the knife with a single guard.

FIG. 17 shows a top view of the knife with a single guard.

FIG. 18 shows the open-side view of the knife with a single guard.

FIG. 19 shows internal detail of the knife with a single guard, in the top view.

FIG. 20 shows the major components of the knife with a single guard ordered for assembly, in a side view of each component.

FIG. 21 shows the major components of the knife with a single guard ordered for assembly, in a top view of each component.

FIG. 22 shows a pair of centering blades to be used in the invention.

FIG. 23 shows the knife with a single guard having two centering blades mounted for use.

### DETAILED DESCRIPTION OF THE INVENTION

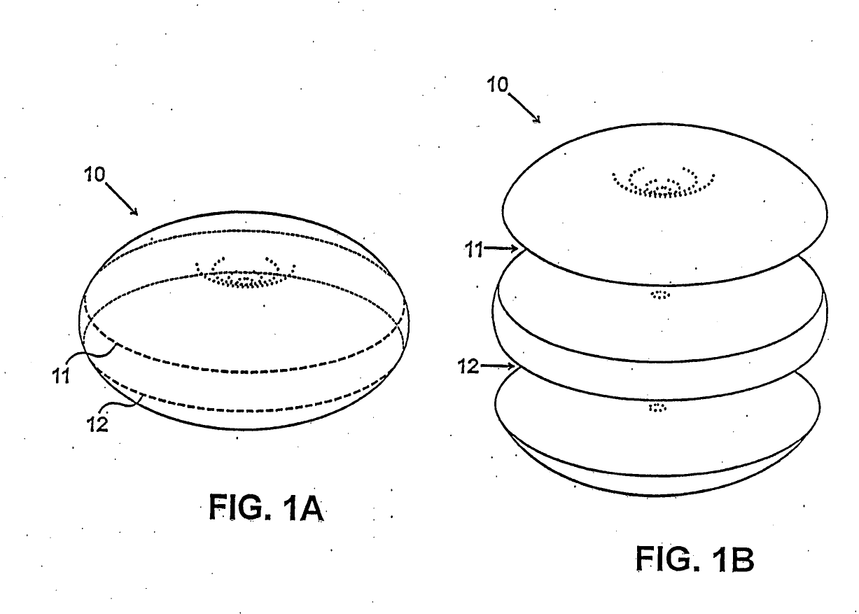

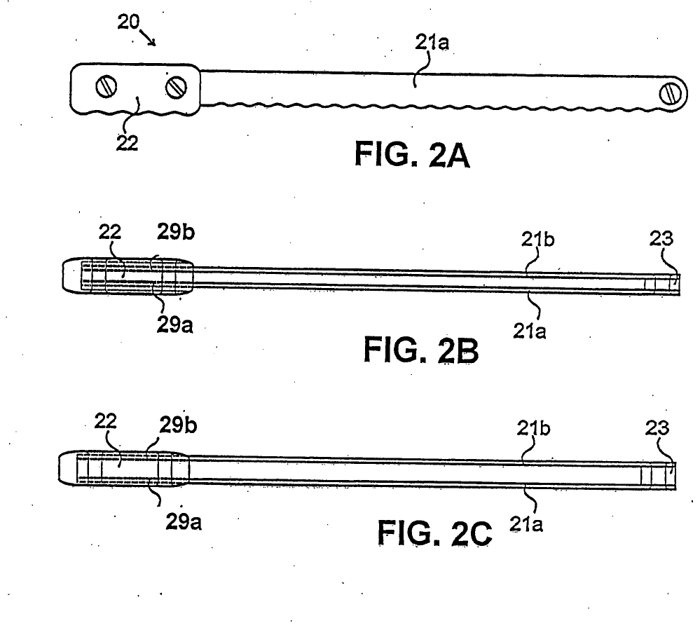

The invention comprises a knife with two or more parallel cutting blades for cutting a bagel 10 or other food item with two or more parallel cuts 11, 12 as shown in FIGS. 1A and 1B. In the invention's knife 20, the blades 21a, 21b are anchored by their tangs 29a, 29b in a handle 22, as shown in FIGS. 2A, 2B and 2C in a manual embodiment, for holding and cutting, and for separating the blades 21a, 21b by a predetermined distance. In a preferred simple two-blade embodiment, shown in FIG. 2A, blades 21a, 21b are anchored by their tangs 29a, 29b at a fixed distance from each other.

Optionally, in a reinforced two-blade embodiment, blades 21a, 21b are also anchored by their tips in a spacer 23 which holds the blades apart at a predetermined distance at the tips. Different embodiments of the invention provide different spacings between the blades as seen in FIGS. 2B and 2C. In a combined embodiment, removable spacing elements are incorporated into the handle and the spacer to permit changing the spacing between the blades. Said removable spacing elements are placed either between the blades or outside them depending on the space desired between the blades.

Although two blades are shown in the figures, the invention provides for the inclusion of three or more blades for cutting multiple slices from a bagel in one cutting process.

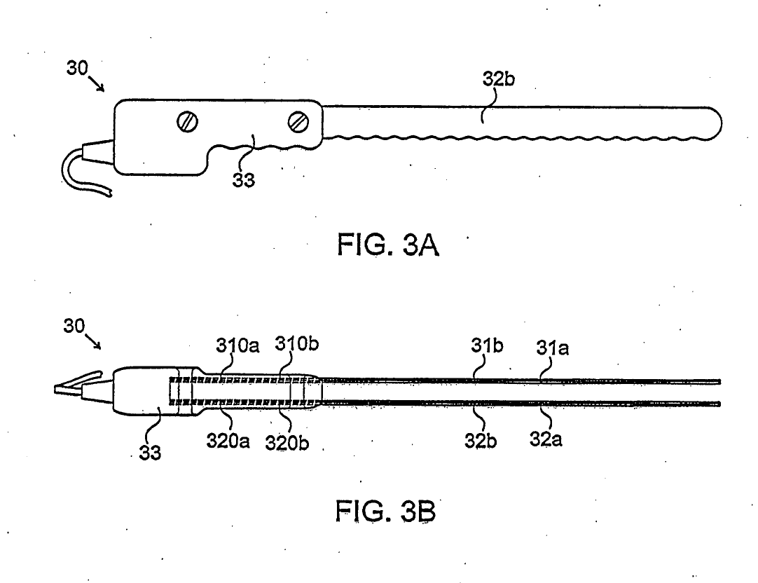

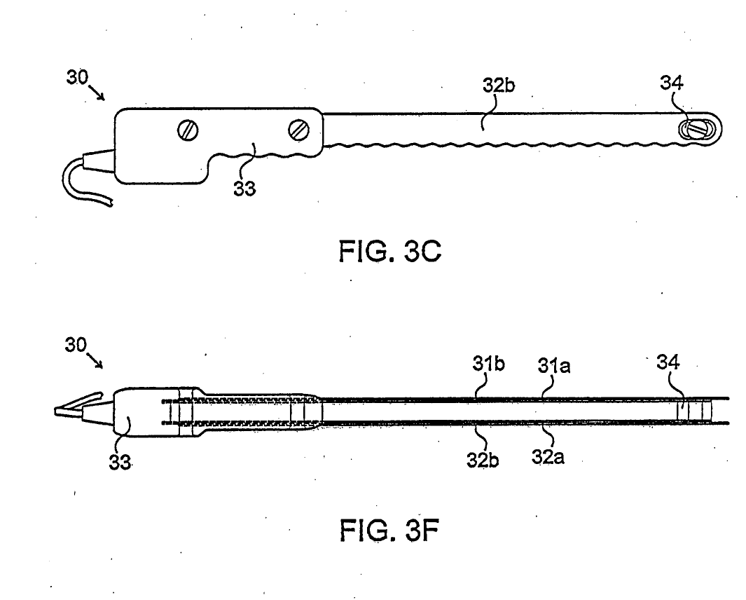

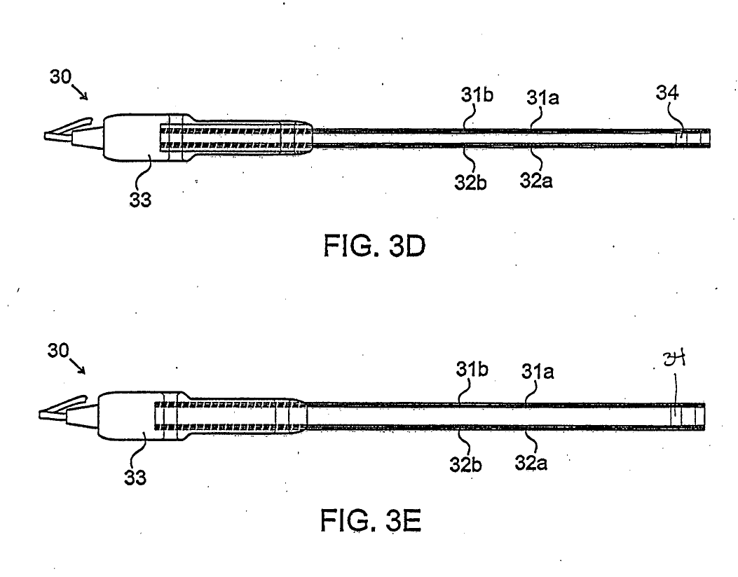

FIGS. 3A and 3B show one design for the invention in a powered embodiment. In the powered set of embodiments, the invention incorporates in its knife 30 conventional double-reciprocating blades 31a, 31b and 32a, 32b driven by a motor in the handle 33 to cut a bagel 10 without sawing effort by the user. In a preferred simple two-double-reciprocating-blade embodiment, shown in FIGS. 3A and 3B, blades 31a, 31b and 32a, 32b are anchored by their tangs 310a, 310b, and 320a, 320b at a fixed distance from each other.

Optionally, in a reinforced two-double-reciprocating-blade embodiment, blades 31a, 31b and 32a, 32b are also anchored by their tips in a spacer 34 which holds the blades apart at a predetermined distance at the tips. As in the manual embodiments, different powered double-reciprocating blade embodiments of the invention provide different spacings between blades 31a, 31b and blades 32a, 32b as shown in FIGS. 3D and 3E. Again, in a combined embodiment, removable spacing elements are incorporated into the handle 33 and the spacer 34 to permit changing the spacing between the blades. Said removable spacing elements are placed either between the blades or outside them depending on the space desired between the blades.

FIG. 3F shows two double blades of the powered embodiment at the ends of their opposing reciprocating strokes. The double reciprocating blades 31a, 31b and 32a, 32b are paired as blade 31a with 32a and blade 31b with 32b so as to allow the spacer 34 anchoring the tips to keep all four blades in alignment for cutting.

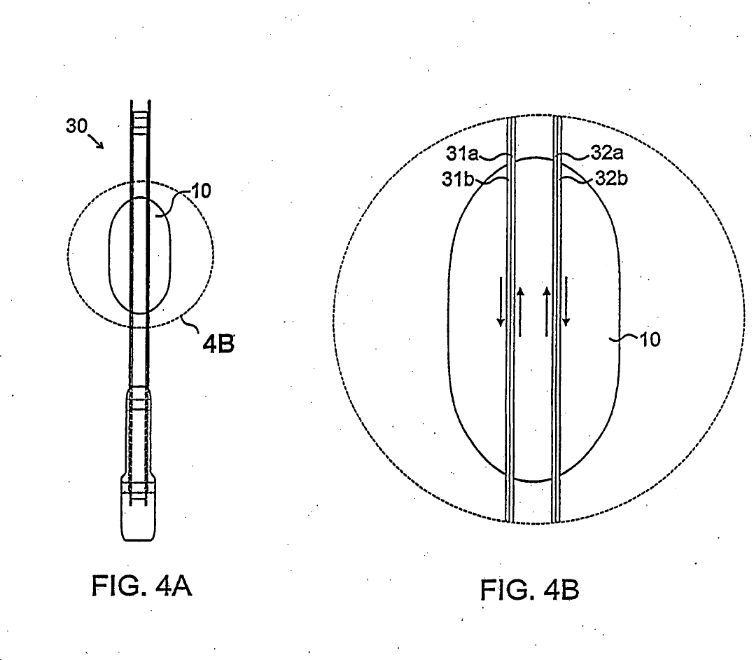

FIGS. 4A and 4B show the operation of the powered blades 31a, 31b and 32a, 32b when cutting a bagel 10. The invention's use of double-reciprocating blades 31a, 31b and 32a, 32b in its powered embodiment applies forces in opposite directions simultaneously to the bagel 10, stabilizing the bagel physically during the cutting process.

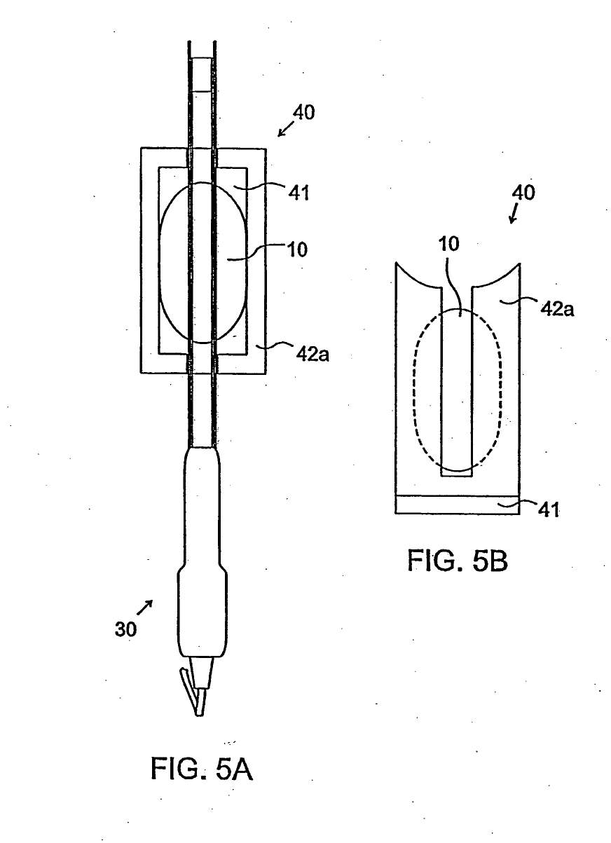

The invention also comprises a holder 40 for bagels to keep the bagel stationary during either manual or powered cutting with the knife 20 or the knife 30. See FIG. 5A for a top view of the holder 40, and FIG. 5B for an end view of holder 40.

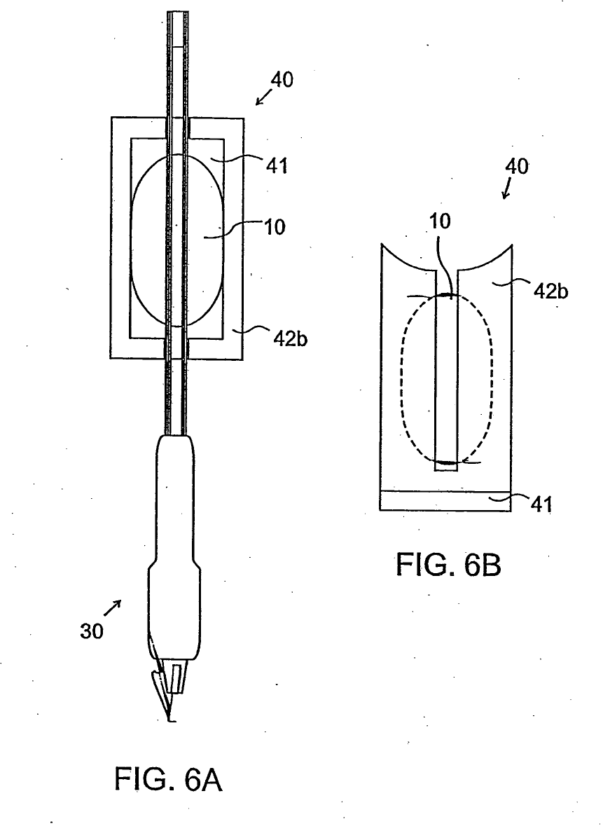

The user may use one set of positioning parts 42a for more-widely-spaced cuts as shown in FIGS. 5A and 5B, and another set of positioning parts 42b for more-narrowly-spaced cuts as shown in FIGS. 6A and 6B. Although a center element between the knife blades or blade pairs may be incorporated in the holder, the invention's holder 40 does not require a center element between the knife blades. The holder's two sides confine the knife blades precisely, and the knife blades are firmly anchored at both ends of the knife as seen in FIGS. 2C and 2D and FIGS. 3C through 3F.

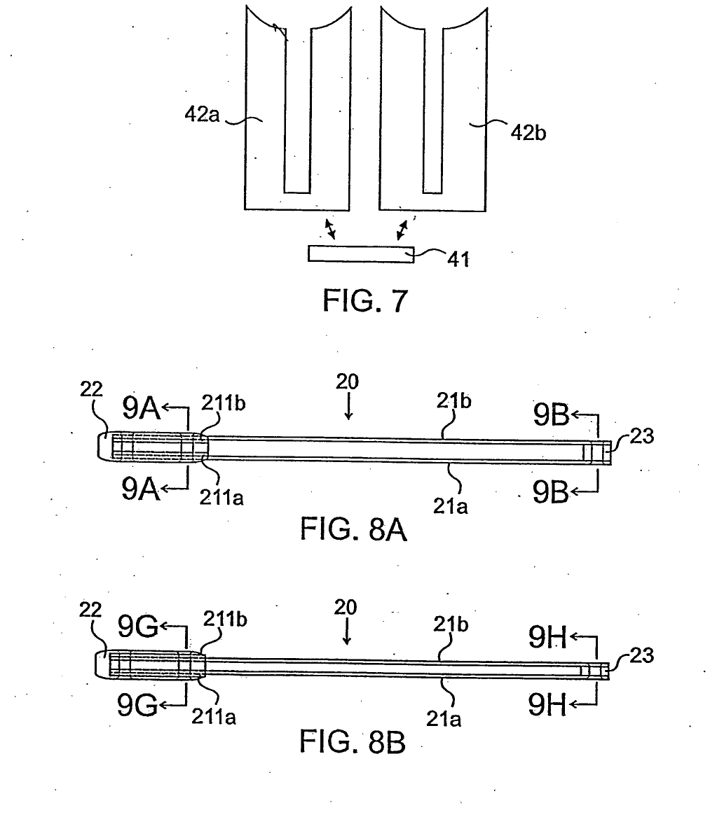

As shown in FIG. 7, the holder comprises a base part 41 and one or more positioning parts 42a, 42b. The holder's base part 41 is the same for all embodiments. The holder's positioning parts 42a, 42b are sized and spaced so as to guide the invention's blades accurately. Either set 42a or set 42b of positioning parts may be mounted on the holder's base part 41.

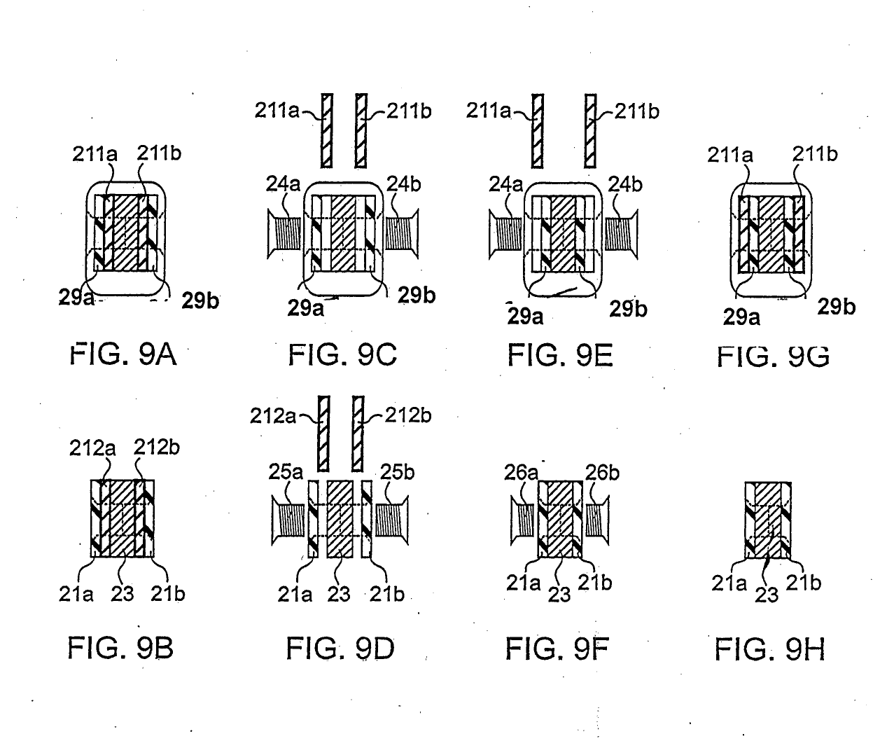

The invention provides a convertible knife embodiment that allows the user to change the space between the knife blades as needed for different thicknesses of cut. See FIGS. 8A, 8B, and 9A-9H for one form of the invention's convertible embodiment. FIG. 8A shows the invention's knife 20 of FIG. 2C with a wider spacing between blades 21a and 21b. FIG. 8B shows the invention's knife 20 of FIG. 2B with a narrower spacing between blades 21a and 21b.

To convert the knife from the form in FIG. 8A to the form in FIG. 8B, the user removes and repositions spacing elements between the blades. See FIGS. 9A and 9B, showing cross sections of the knife handle 22 and the blade spacer 23 respectively for the knife configuration of FIG. 8A. In FIG. 9A, blade tangs 29a, 29b are positioned outside blade spacers 211a, 211b. The user removes screws 24a, 24b as shown in FIG. 9C, and then removes tang spacers 211a, 211b. In FIG. 9B, blades 21a, 21b are positioned outside spacers 212a, 212b. The user removes screws 25a, 25b as shown in FIG. 9D, and then removes spacers 212a, 212b.

In the next step of conversion, the user repositions blade tangs 29a, 29b closer together as shown in FIG. 9E, and reinserts tang spacers 211a, 211b as shown, outside blade tangs 29a, 29b. The user then repositions blades 21a, 21b closer together as shown in FIG. 9F, removing tip spacers 212a, 212b altogether and replacing screws 25a, 25b with shorter screws 26a, 26b. On refastening all screws as shown in FIGS. 9G and 9H, the invention's blades are now positioned closer together as shown in FIG. 8B.

As mentioned above, many people cut themselves while trying to slice a bagel. In order to address this safety issue and improve the safety of the knife and of all knives, the invention further provides a range of additional embodiments with safety features. The safety features include one or two rigid guards that isolate the cutting edges of the blades from a person's fingers and reinforce the longitudinal stiffness of the blades so that they do not laterally wobble during cutting.

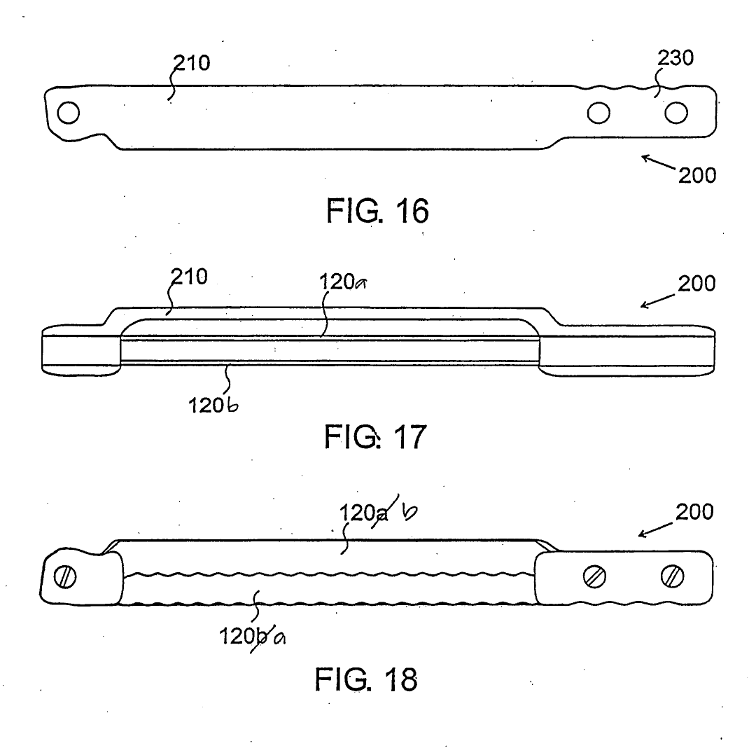

The invention provides a double-sided guard knife and a single-sided guard knife. The dual-sided guard knife 100 is shown in FIGS. 10-12. It provides longitudinal guards 110.1 and 110.2 opposite the outer facing sides of the blades 120.1, 120.2. The guards are spaced to permit bagels, rolls or other food items to pass between the guards 110.1 and 110.2 in order to be cut by the blades 120.1 and 120.2. FIGS. 16-21, show the single-sided guard knife. All embodiments having longitudinal guards 110, 210 may have the same spacer structures and functions as described above for other embodiments. For all embodiments, the invention may be fabricated either in integrated form for permanent use in a single configuration, or in modular form for disassembly, cleaning, part replacement, or reconfiguration of spacings and blades. Those skilled in the art will understand that existing, single bladed knives may be retro-fitted with single or double sided guards.

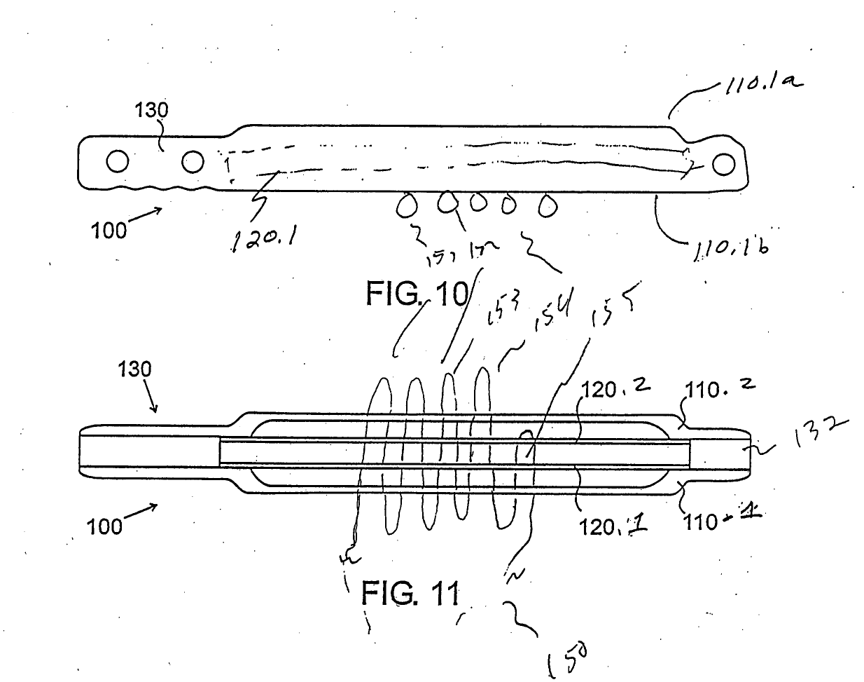

Turning to FIGS. 10, 11, knife 100 has a handle 130, a pair of parallel blades 120.1, 120.2 and a corresponding pair of guards 110.1, 110.2 disposed outside the respective blades. The guard 110.1 has an upper edge 110.1a and a lower edge 110.1b. As seen in FIG. 10, the blades 120.1, 120.2 in phantom are laterally and vertically isolated. In other words, even if a person's hand 150 or fingers 151-155 were beneath the blades 120.1, 120.2, the lower edges 110.1b, 110.2b (not shown) of the guards would protect the hand 150 and fingers 151-155 from the blades 120.1, 120.2. The guards 110.1, 110.2 completely cover the outer side of each blade 120.1, 120.2 and extend below the cutting edges of the blades to protect the hand 150 or fingers 151-155 of a person who mistakenly places his hand or fingers beneath the knife 100 while cutting.

In one embodiment, the guards 110.1, 110.2, the handle 130 and a tip spacer 132 are molded around the blades 120.1, 120.2 to form the knife 100. The blades 120.1 and 120.2 are thus laterally reinforced by the handle, tip spacer and guards. The structure of the knife 100 is relatively rigid. The blades 120.1, 120.2 are supported laterally and vertically at each of their ends. This enables the invention to use knives with relatively thin blades, thereby reducing the cost of the materials for the knife. During cutting, dynamic forces generated by the person making the cut and frictional forces of the bread that resist the cut and will tend to bend thin knife blades so that they wobble transverse to the direction of cut. However, the structure of the invention reinforces the lateral stability of the dual, thin blades by holding them relatively stiff and thus resistant to lateral wobble.

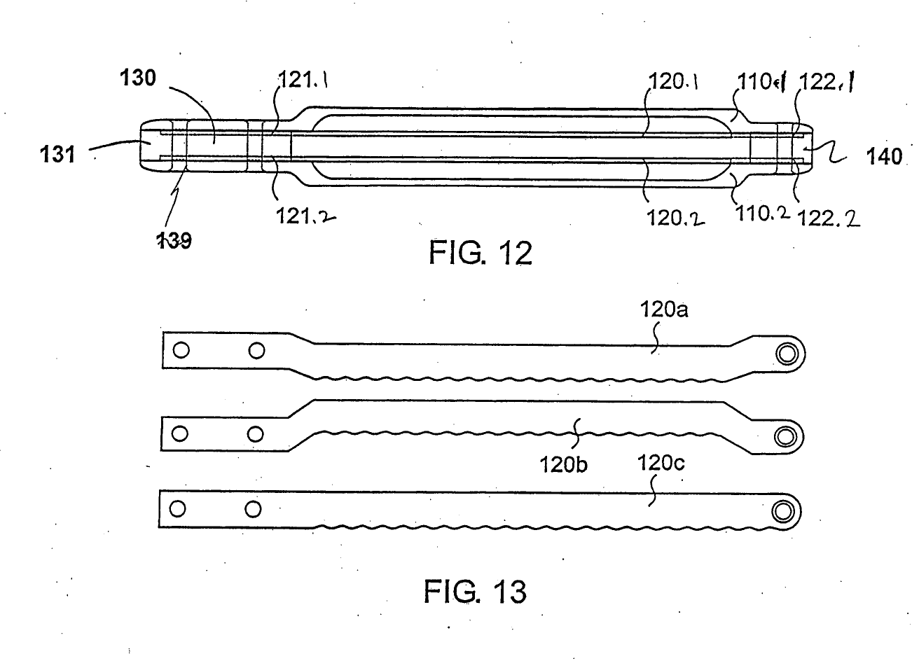

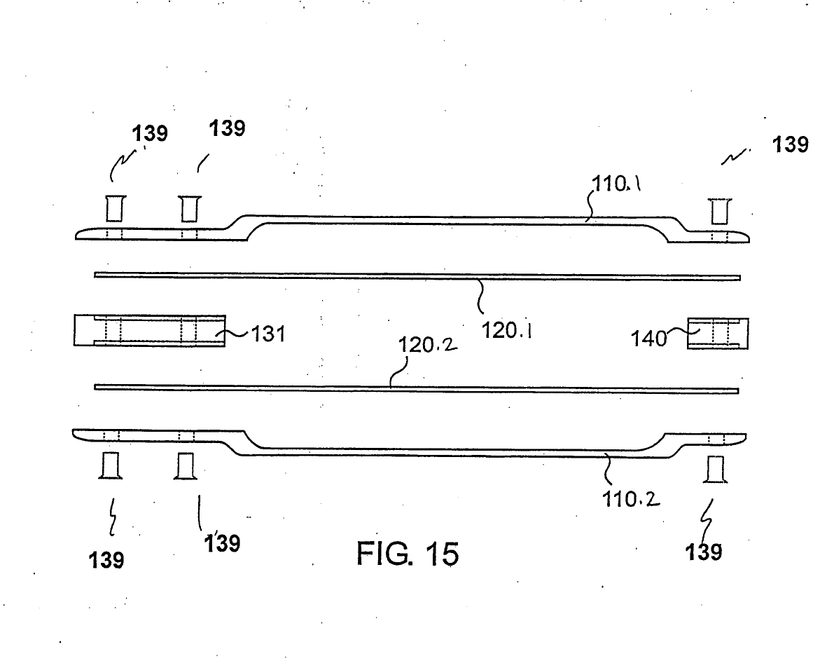

The knife 100 may also be constructed from individual elements that are assembled together with suitable fasteners. See FIGS. 12 and 15 which show, respectively, assembled and exploded views of the structure of one dual-sided guard knife. A handle spacer 131 and the tip spacer 140 are in the center of the structure. Blades 120.1, 120.2 are on opposites sides of the handle and tip spacers and guards 110.1, 110.2 are outside the blades. Rivets 139 extend into openings of the guards, blades, handle and tip spacer to assemble and hold the parts together. The tangs 121.1, 121.2 of the blades 120.1, 120.2 are anchored in the knife handle element 131 by one or more rivets 139. The tips 122.1, 122.2 ofthe blades are likewise anchored in a tip spacer 140 by rivet 139. The guards 110.1, 110.2 are anchored both at the handle 130 and the tip spacer 140 by the same rivets.

In the dual blade embodiments of the invention the blades may be offset vertically with respect to each other. In other words, the blades, though parallel, may have their cutting edges disposed at different depths with respect to each other. This allows the cutting edge edge of one blade to lead the cutting edge of the other blade. The offset arrangement of the leading cutting edges reduces friction experienced by two blades that are both parallel and aligned. Where the blades are aligned with their lower edges in the same plane, the center cut slice between the blades may become compressed. If so, the compressed slice presses against both the blade surfaces and increases frictional force that inhibits cutting. By jogging or offsetting the relative depths of the cutting edges of the blades with respect to each other, the leading edge of the lower blade acts, at least initially, like a single blade. There is no compressive force exerted on the inside surface of the leading edge of the lower blade because the other blade is vertically offset from it.

The offset blades may be fabricated in any of several forms to facilitate different types of cutting. FIG. 13 shows three different blades 120a, 120b, and 120c for use in the knife having two guards. The top blade 120a in FIG. 13 places the blade's cutting edge closer to the lower edge of the guard. The middle blade 120b in FIG. 13 places the blade's cutting edge farther from the lower edge of the guard. The bottom blade 120c in FIG. 13 places the blade's cutting edge at a middle distance from the lower edge of the guard. The invention may thus be fabricated with two of three blades to provide staggered leading edges; facilitating cutting where making an initial cut with a single blade constitutes an advantage.

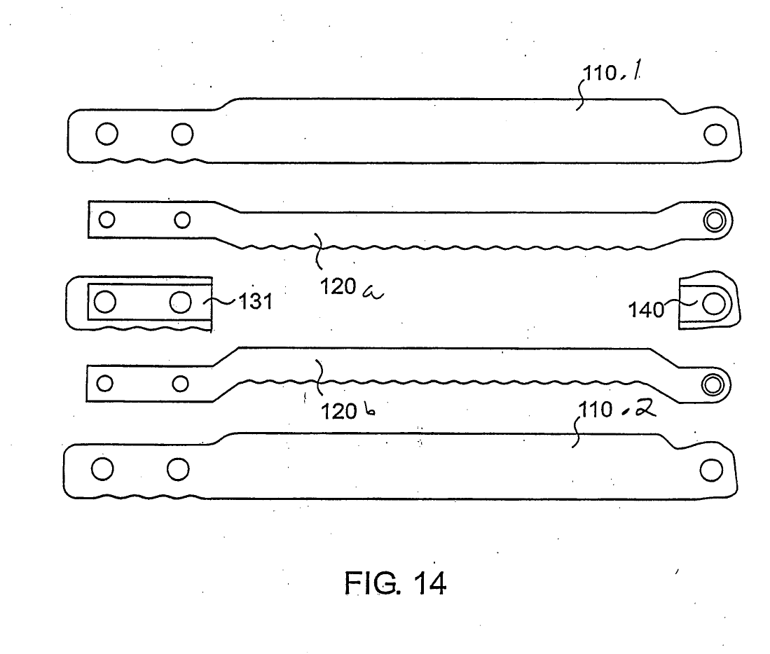

FIGS. 14 and 15 show the major components of the knife 100 with a dual guard assembly, in a side view and top assembly view. One guard 110.1 is at top, then a blade 120a, then a handle spacer 131 and a tip spacer 140, another blade 120b, and the second guard 110.2. The handle 130 comprises handle spacer 131 and the handle ends of the guard 110. The assembly may be done once when the knife is fabricated in an integrated embodiment, or may be done by the user at any time for the modular embodiments.

A knife 200 provides one longitudinal guard 210 on only one side of the blades 120a and 120b. The guard 210 is spaced from the proximate blade to permit the cutting of two slices of bread from the side of a loaf of bread or to cut a bagel into three slices. The guard 210 blocks hand access to the cutting edges of the blades 120a, 120b. The single-sided knife 200 may be fabricated for either right-hand or left-hand use.

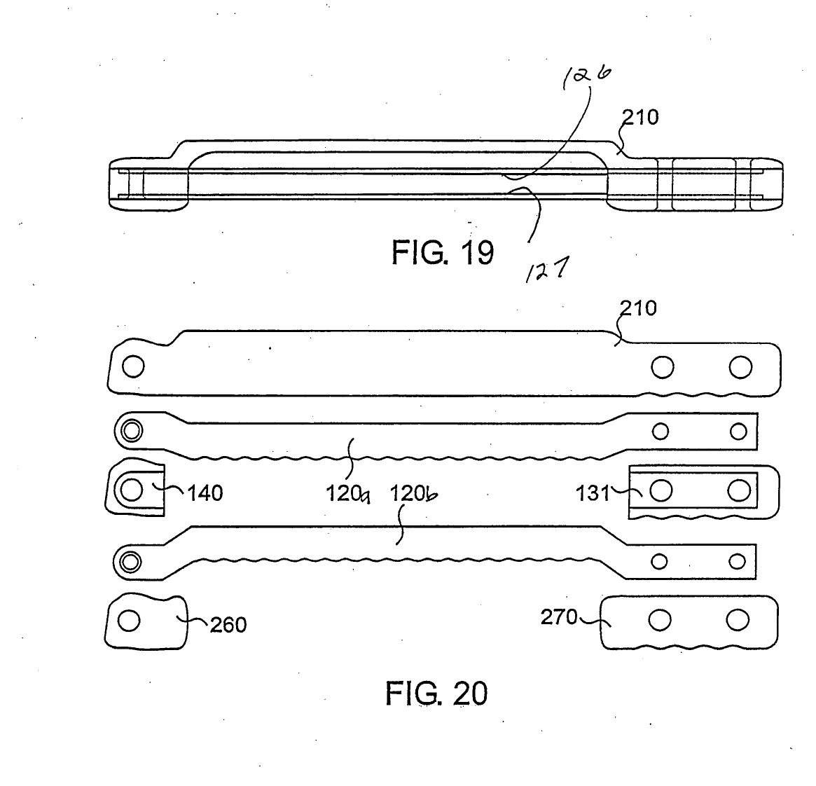

FIG. 16 shows an inverted closed-side view of the knife 200 with a single guard 210, in an embodiment for right-handed use in carving from the side or end of a large food item such as a roast or a loaf of bread. The view is inverted top-to-bottom to make it consistent with the two figures that follow. The closed side of this embodiment is similar to the closed side of the knife embodiment 100. FIG. 17 shows a top view of the knife 200 with a single guard 210, in an embodiment for right-handed use. Note that the guard 210 of this embodiment may be made thicker than that of the full guard embodiment. FIG. 18 shows the open-side view of the knife 200 with a single guard 210, in an embodiment for right-handed use. Note the relative positions of the two cutting blades 120a, 120b that have their lower, leading edges vertically spaced or offset from each other. The blade 120a closer to the viewer is positioned lower than the blade 120b. This positioning may be reversed or changed as required. This positioning may be done in the same way for the dual-sided guard knife 100. FIG. 19 shows some internal detail of the knife 200 of FIGS. 16-18.

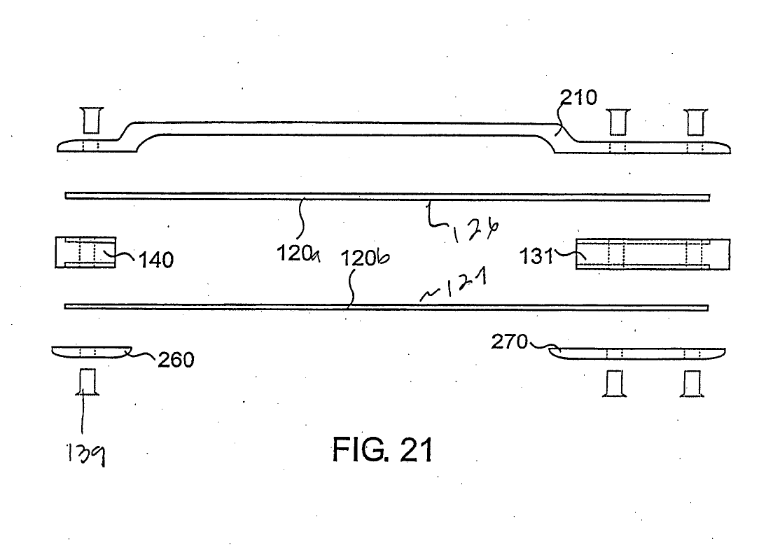

FIG. 20 shows the major components of the knife 200 of FIGS. 16-19, in side views. FIG. 21 shows an expanded assembly view of the element. A guard 210 is at top, then a blade 120a, then a handle spacer 131 and a tip spacer 140, another blade 120b, and a tip facing 260 and a handle facing 270. The handle 230 comprises handle spacer 131, the handle end of the guard 210, and the handle facing 270. The assembly may be done once when the knife is fabricated in an integrated embodiment, or may be done by the user at any time for the modular embodiments. In one embodiment, rivets 139 extend through openings in the parts to secure the parts to the handle and tip spacers.

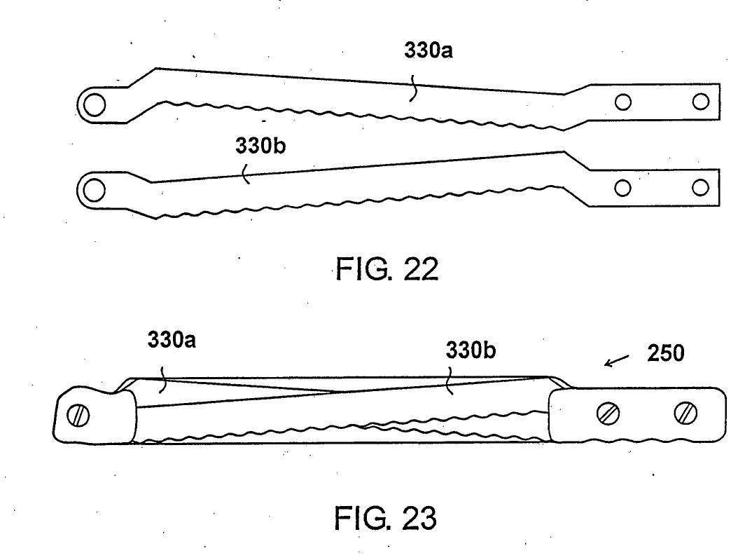

The knife may be fabricated so as to position the blades with their cutting edges at opposing longitudinal angles. See FIGS. 22 and 23. A cut made with the knife 250 will start near one end of the blade, either the handle end or the tip end. One blade will engage the food item first and the cutting action will move the food item toward and past the center of the blade's length. A return cut will then engage the food item with the other blade slanted to move the food item in the opposite direction, thereby tending to keep the food item centered along the length of both blades. FIG. 22 shows a pair of centering blades 330a, 330b to be used in the invention, and FIG. 23 shows the knife 250 with a half guard having two centering blades 330a, 330b mounted for use. This embodiment also reduces the amount of bread surface that is on the inner faces of the knives. Reducing the area of surface contact on the opposing surfaces 126, 127 (See FIG. 19) reduces the frictional forces generated by the central, sliced bread on the blades and makes it easier to simultaneously cut three slices.

The invention produces two or more precisely-aligned, clean, quick, safe cuts in a bagel, roll or other food item with a single cutting operation. In the case of the bagel, the result is a cut bagel usable in creating sandwiches with three or more layers: a club bagel sandwich. The invention thus provides kitchen service as a bagel knife in situations requiring fast, safe, accurate, attractive food preparation and presentation.

In its single guard embodiments, the invention also produces two or more precisely-aligned, clean, quick, safe cuts in other food items including large items requiring end or side slices. The invention's ability to perform multiple simultaneous cuts without compromising safety or quality in a variety of roles constitutes a significant advantage in food preparation and presentation productivity.

The invention further contemplates and the appended claims will cover embodiments of the invention that use a single blade and a single side guard and single or double bladed versions with adjustable side guards. The relative spaces between the side guards, between the blades, and between the side guards and the blades are adjustable. The distance between the blades in the double bladed version and the distance between either side guard the an adjacent blade may be varied by using different size spacers at the ends of the blades. Another way to vary the distance is to provide a spacer with a threaded screw and external adjusting nuts to moved the blades or the guards. For example, one could put a fixed spacer between the ends of two blades and then springs between the blades ends the ends of the spacer. The threaded spacer screw would extend beyond the side guards and would be held in place by springs acting between the blades and the guards and the external wing nuts. As the wing nuts were tightened, the guards would move toward each other and reduce the space between the adjacent blade and guard. Likewise, as the wing nuts were loosed, the springs would urge the guards farther away from the adjacent blades.

While the above embodiments show a manual knife, those skilled in the art understand that the manual knife may be adapted to receive a motor that reciprocates the blades.

What is claimed is:

1. A bagel knife for slicing a bagel into three or more layers, comprising:
a knife having two or more parallel blades that extend from a tip at one end to a tang at the other and are spaced apart a sufficient distance to permit a slice of bread to pass between the space between the two blades;
a handle disposed at the tang end of the blades and secured to the tangs; a tip holder disposed at the other end of the blades and secured to the tips of the blades.

2. The bagel knife of claim 1 wherein the knife is electrically powered.

3. The bagel knife of claim 2 wherein the knife comprises two or more pairs of reciprocating blades.

4. The bagel knife of claim 1 further comprising a spacer near the tip of each blade for maintaining a fixed distance between the blades.

5. The bagel knife of claim 4 further comprising a spacer near the tip of each pair of blades for maintaining a fixed distance between the pairs of blades.

6. The bagel knife of claim 1 wherein the knife further comprises:
spacers for fixing one or more distances between the parallel blades; and
anchoring means for fastening the parallel blades to the spacers to keep the blades firmly spaced apart.

7. A knife for slicing a food item into three or more layers, comprising:
a knife having two or more parallel blades spaced apart and anchored by a handle covering the tang of each blade; and
at least one rigid side guard mounted on one side of the knife blade and extending from the handle to the tip of said adjacent blade.

8. The knife of claim 7 wherein the knife is electrically powered.

9. The knife of claim 8 wherein the knife comprises two or more pairs of reciprocating blades.

10. The knife of claim 7 further comprising a spacer near the tip of each blade for maintaining a fixed distance between the blades.

11. The knife of claim 10 further comprising a spacer near the tip of each pair of blades for maintaining a fixed distance between the pairs of blades.

12. The knife of claim 7 further comprising a second, rigid side guard mounted on the other side of the knife and also extending from handle and to the tip of the blade adjacent the second, rigid side guard.

13. The knife of claim 7 wherein the rigid guard further comprises one side part for guarding and enclosing one side of the blades.

14. The knife of claim 7 wherein the knife further comprises:
a spacer for fixing a spacing distance between opposite tips of the parallel blades; and
anchoring means for fastening the parallel blades firmly to said spacer.

15. The knife of claim 7 wherein the blades are staggered in position so that a leading cutting edge of one blade engages an item to be cut before the leading cutting edge of the other blade engages the item to be cut.

16. The knife of claim 7 wherein the blades are longitudinally angled in position so that the surface area of juxtaposed bread slices between the blades is less than the surface area ofjuxtaposed bread slices between parallel and aligned blades.

17. A method for slicing a bread product comprising:
providing a knife with two blades spaced apart from each other enough to allow a central slice of bread to pass between the knives;
cutting the bread product with the dual bladed knife to slice the bread product into no more than three slices of bread.

18. A knife comprising:
a handle;
an elongated cutting blade extending from the handle and terminating in a tip and having a leading cutting edge disposed in a direction transverse to the length of the blade; and
a elongated side guard extending from the handle and terminating proximate the tip of the blade and having a protective edge disposed in a direction transverse to the length of the side guard and extending beyond the leading cutting edge of the blade.

19. The knife of claim 18 further comprising another elongated cutting blade, extending from the handle and terminating in a tip and having a second leading cutting edge disposed in a direction transverse to the length of the blade; and
another elongated side guard extending from the handle and terminating proximate the tip of the second blade and having a protective edge disposed in a direction transverse to the length of the side guard and extending beyond the leading cutting edge of the second blade.

20. The knife of claim 19 wherein one cutting blade has a leading cutting edge that extends beyond the leading cutting edge of the other cutting blade and the protective edges of both side guards extend beyond the longer of the two cutting blades.

21. A protective guard for knife comprising an elongated side guard having means for attaching to a handle of a knife, a length extending from the handle and terminating proximate the tip of the blade of the knife and having a protective edge disposed in a direction transverse to the length of the knife blade and extending beyond the cutting edge of the knife blade.
